(19) United States
(12) Patent Application Publication
(10) Pub. No.: US 2008/0163836 A1
(43) Pub. Date: Jul. 10, 2008

(54) Camshaft phaser having dual counter-threaded helical mechanisms

(76) Inventors: Elias Taye, Macomb Township, MI (US); Bruno Lequesne, Troy, MI (US)

Correspondence Address: DELPHI TECHNOLOGIES, INC., M/C 480-410-202, PO BOX 5052, TROY, MI, 48007, US

(21) Appl. No.: 11/651,749

(22) Filed: Jan. 10, 2007

(51) Int. Cl. F01L 1/34; F16D 1/12

(52) U.S. Cl. 123/90.15; 464/160

(57) ABSTRACT

A mechanically-actuated camshaft phaser for varying the phase of a camshaft in an internal combustion engine. The phaser comprises two colinear helical mechanisms having opposite-handed helices engaging a common nut for common rotation. One helical mechanism is operatively attached to a sprocket or pulley in time with an engine crankshaft. The other helical mechanism is operatively attached to an engine camshaft. A motive system drives the nut axially of itself along the helical mechanisms, causing a phase shift between the mechanisms and hence between the crankshaft and the camshaft. The preferred helical mechanisms are ball screws, and the preferred motive system is a worm gear driven by a worm on the shaft of an electric motor.

### TECHNICAL FIELD

The present invention relates to a mechanism for varying the timing of combustion valves in internal combustion engines; more particularly, to camshaft phasers for varying the phase relationship between an engine's crankshaft and camshaft; and most particularly, to a mechanically-actuated camshaft phaser having dual counter-threaded helices and a common nut for changing the phase relationship of the two helices.

### BACKGROUND OF THE INVENTION

Camshaft phasers (“cam phasers”) for varying the timing of combustion valves in internal combustion engines are well known. A first element, known generally as a sprocket element, is driven by a chain, belt, or gearing from an engine's crankshaft. A second element, known generally as a camshaft plate, is mounted to the end of an engine's camshaft, typically an intake valve camshaft in engines having dual camshafts.

In the prior art, cam phasers typically employ one of two different hydraulically-actuated arrangements for achieving variable valve timing.

In a first arrangement referred to in the art as a “spline-type” phaser, the sprocket element is provided with a first cylinder having helical splines on its inner surface, and the camshaft element is provided with a second cylinder having helical splines on its outer surface. The first and second cylinders nest together axially with the splines fully meshed. When one cylinder is driven axially of the other, the helical splines cause relative rotation therebetween, thereby changing the phase relationship. Typically, an axially-acting ram is controllably displaced by pressurized engine oil pirated from the engine oil supply system.

In a second arrangement referred to in the art as a “vane-type” phaser, the sprocket element is provided with a stator having a central opening and having a plurality of lobes extending radially inward into the central opening and spaced apart angularly of the stator body. The camshaft element is provided with a rotor having a hub and a plurality of outwardly extending vanes. When the rotor is installed into the stator, the vanes are disposed between the lobes, thereby defining a plurality of rotor-advancing chambers on first sides of the vanes and a plurality of rotor retarding chambers on the opposite sides of the vanes. Again, pressurized oil is controllably admitted to either the advance chambers or the retard chambers to selectively alter the phase angle between the crankshaft and the camshaft, thereby varying the timing of the engine valves.

While effective and relatively inexpensive, both types of prior art hydraulically-actuated cam phasers suffer from several drawbacks.

First, at low engine speeds engine oil pressure tends to be low, and sometimes unacceptably so; therefore, the response of conventional cam phasers is sluggish at low engine speeds.

Second, at low environmental temperatures, and especially at engine start-up, engine oil displays a relatively high viscosity and is more difficult to pump and to supply to a phaser in a rapid-response fashion.

Third, using engine oil to drive a phaser is parasitic on the engine oil system and can lead to requirement for a larger oil pump.

And finally, for fast actuation, a larger engine oil pump may be necessary, resulting in an additional energy drain on the engine.

What is needed in the art is a camshaft phaser wherein the phaser is mechanically actuated without resort to pressurized oil and therefore phaser performance is not subject to variation in engine oil pressure, temperature, or viscosity.

It is a principal object of the present invention to vary engine valve timing by varying camshaft phase angle mechanically without reliance on pressurized oil.

### SUMMARY OF THE INVENTION

Briefly described, a camshaft phaser in accordance with the invention comprises two colinear helical mechanisms abutting end-to-end and having opposite-handed helices engaging a common nut bridging the helices for common rotation thereof. One helical mechanism may be operatively attached to a sprocket or pulley in time with an engine crankshaft. The other helical mechanism may be operatively attached to an engine camshaft. A motive system drives the nut axially of itself and the phaser along the helical mechanisms, causing a phase shift between the mechanisms and hence between the crankshaft and the camshaft. The preferred helical mechanisms are ball screws, and the preferred motive system is a worm gear driven by a worm mounted on the shaft of an electric motor.

### BRIEF DESCRIPTION OF THE DRAWINGS

The present invention will now be described, by way of example, with reference to the accompanying drawings, in which:

FIG. 1 is an elevational cross-sectional view of a first embodiment of a camshaft phaser in accordance with the invention;

FIG. 2 is an elevational cross-sectional view of the first phaser embodiment shown in FIG. 1, taken orthogonal to the view shown therein;

FIGS. 3 and 4 are elevational cross-sectional views of two second embodiment arrangements of a camshaft phaser in accordance with the invention;

FIG. 5 is a schematic cross-sectional view of a third embodiment of a camshaft phaser in accordance with the invention; and

FIG. 6 is a perspective view, partially in cutaway, of a fourth embodiment of a camshaft phaser in accordance with the invention.

The exemplifications set out herein illustrate currently preferred embodiments of the invention. Such exemplifications are not to be construed as limiting the scope of the invention in any manner.

### DESCRIPTION OF THE PREFERRED EMBODIMENTS

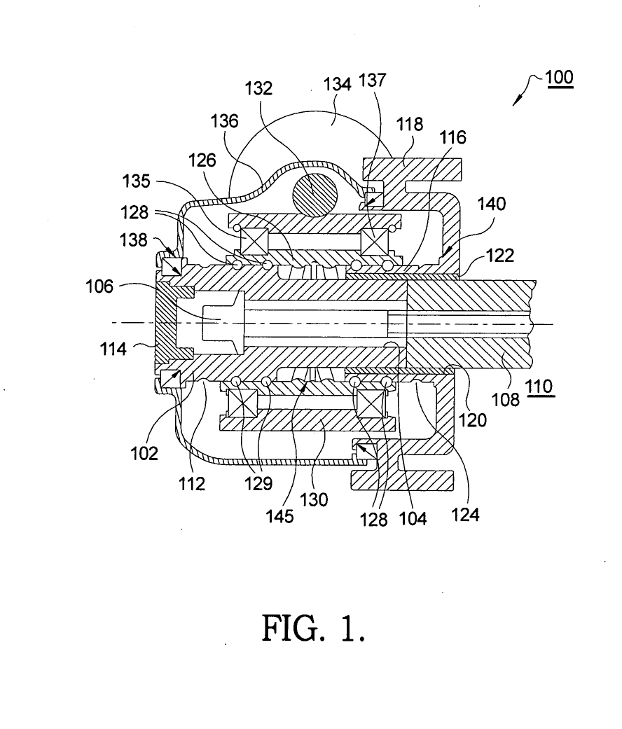

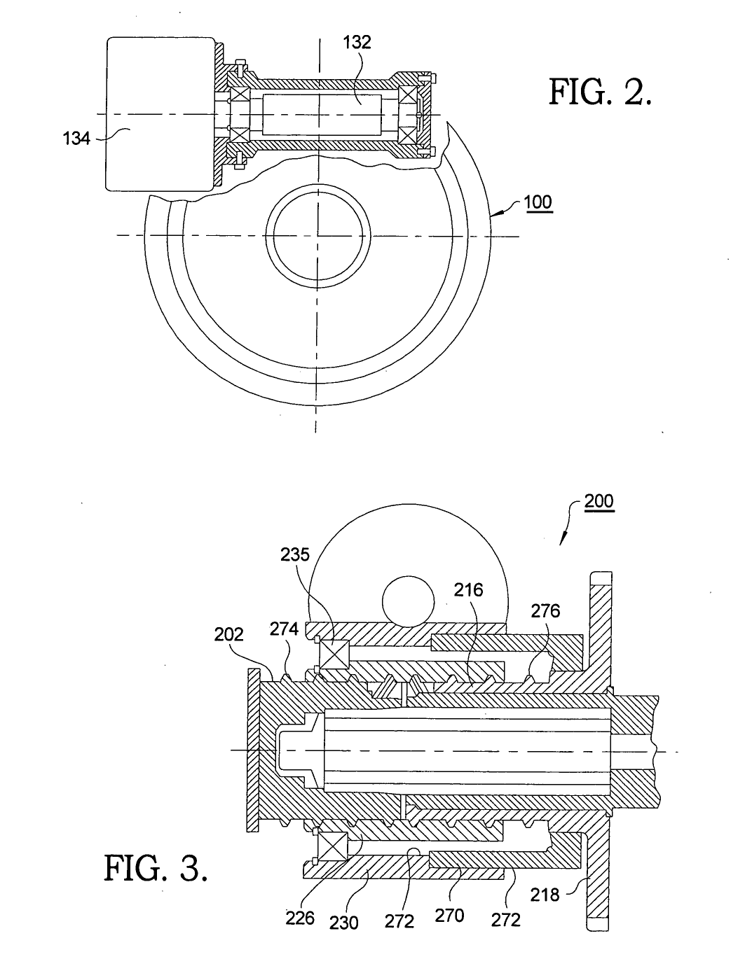

Referring to FIGS. 1 and 2, a first embodiment 100 of a mechanically-actuated oil-less cam phaser in accordance with the invention employs a first ball screw 102 having a stepped central bore 104 for accommodating a central bolt 106 that attaches phaser 100 to a camshaft 108 of an internal combustion engine 110. First ball screw 102 is provided with a helical ball race 112 (may be a multiple helix as desired) on the outer surface thereof, having a first handedness, for example, a left-handed helix as shown in FIG. 1. Preferably, a cap 114 closes bore 104. In operation, first ball screw 102 thus rotates with camshaft 108.

A second ball screw 116 extends axially from a drive pulley or sprocket 118 for rotation therewith, which pulley or sprocket in operation is driven conventionally in time with a crankshaft (not shown) of engine 110. Screw 116 and pulley 118 are provided with a second stepped bore 120 that accommodates a bearing 122 extending along the surface of both camshaft 108 and/or first ball screw 102 such that screw/pulley 116,118 can rotate thereupon. Second ball screw 116 is provided with a helical ball race 124 (may be a multiple helix as desired) on the outer surface thereof, having a second handedness, for example, a right-handed helix as shown in FIG. 1, opposite to the handedness of first ball race 112.

A nut 126 surrounds and overlaps the adjacent portions of first and second ball screws 102,116. Nut 126 captures and is supported by a plurality of balls 128 disposed in races 112,124 and corresponding recesses or rails 129 in nut 126. It will be seen that shifting nut 126 axially of ball screws 102,116 causes the rotational phase relationship between the ball screws to change, thus changing the phase relationship between the engine crankshaft and camshaft. This is the fundamental basis of the present invention, and of the various embodiments shown and discussed herein.

The rails 129 in nut 126 also form helical patterns matching the races in ball screws 102,116, such that a right-hand helix in nut rails 129 faces the right-hand helix on the ball screws, and a left-hand helix in nut rails 129 faces the left-hand helix on the ball screws. The nut rails helices form the same angle as the ball screw race they face. Ball screws 102,116 are spaced apart by a gap 145. This gap is at least as long as the total axial displacement of the nut, so that at no time during operation the nut rails 129 with a right-hand pattern overlap with the left-hand ball screw helix, and vice-versa.

Ball screws 102,116 preferably have a high helix angle, defined herein as a pitch angle of more than 25° from the camshaft axis. In a presently-preferred helical mechanism, the helix angle is 32°. High helix angles make for easy axial translation of nut 126.

A currently-preferred motive mechanism for driving nut 126 axially of the phaser includes a worm gear 130 having appropriate angled splining (not visible) on its outer surface and meshed with a worm 132 driven by an electric motor 134 mounted to a phaser housing 136 (housing may not be needed if phaser is included within an engine valve cover). Worm gear 130 is supported for both rotational and axial translational motion (motion pattern is helical) on outer and inner thrust bearings 135,137 which couple worm gear 130 to nut 126. Thus, when worm 132 is actuated by motor 134 in response to signal from an engine controller (not shown), nut 126 is driven axially of phaser 100 in one direction or the other to vary the phase relationship between the crankshaft and the camshaft to vary the timing of valves (not shown) in engine 110 actuated by the camshaft. When constant phasing is desired, the worm/worm gear system is stationary, and sprocket 118, nut 126, first and second ball screws 102,116, and camshaft 108 rotate as one.

As shown in FIG. 1, phaser 100 is in the middle of its range. The free space on either side of nut 126 allows for worm gear 130 and nut 126 to move axially towards either extreme phasing position (full advance and full retard). Note that nut 126, pulley 118, and ball screw 102 can be arranged to form hard stops 138,140 at both ends of motion. Normally, the controller will keep the system within a predetermined range of axial motion; however, stops 138,140 can be useful in preventing unlimited phasing and consequent engine damage in case of controller failure.

Embodiment 100 may be easily assembled to an engine and its camshaft. The entire phaser may be pre-assembled offline and then bolted in a single assembly step to the camshaft 108 via central bolt 106.

A worm gear motive mechanism is currently preferred because of its high gear ratio, permitting use of a relatively small motor, and its inherent self-locking abilities. The latter is critical in phaser application because the camshaft load torque features large oscillations, typically from about +12 Nm to about −8 Nm. These oscillations could drive back a motive mechanism and thereby cause the relative camshaft angular position to oscillate; obviously, it is desirable for the camshaft angular position to be steady at a desired phase angle. Self-locking is obtained by choosing an appropriate worm gear angle for a given situation, considering the coefficient of friction of the gear materials, etc. A small angle of the gear teeth to the gear axis is desirable, preferably less than 5°. A currently-preferred gear tooth angle is 3°.

Electric motors are desirable for the present use because they are easy to control and are easily provided in any size necessary to generate whatever torque is required to overcome the camshaft torque and to provide a specified rate of phasing between the first and second helical mechanisms.

Other types of motive means are comprehended by the invention. For example, spring/brake systems are known wherein a spring tends to drive the mechanism in one direction and a brake tends to oppose that spring force; for example, a spring may urge the phaser toward a full-retard position (for an intake camshaft, or full-advance for an exhaust camshaft), as in shutdown or startup mode. The actual phase angle is then adjusted by modulating the amount of braking force exerted on the mechanism. A preferred brake in such a system is an electromagnetic brake, and especially a hysteresis brake. A spring/brake system may be less expensive than a motor system; however, the performance of a spring/brake system, for instance, the phasing rate, may be more limited.

For another example, hydraulically-actuated motive means for driving the nut axially are fully comprehended by the invention.

As shown in FIGS. 1 and 2, worm gear 130 is cylindrical, centered on the camshaft and phaser axis, and its motion when actuated is helical. However, the critical part of this motion is the axial component that drives nut 126. It will be obvious to one of ordinary skill in the gearing arts that the worm and worm gear may be arranged such that the worm gear pattern is only axial; therefore, the motion pattern of the worm gear 130 is only a matter of design. A pattern limited to axial motion only may be preferred, for example, if other motive principles such as a spring or hydraulics are used.

Motor 134 and worm 132 are shown in FIGS. 1 and 2 as being orthogonal to the phaser axis. This is currently considered to be advantageous because of the resulting easier and more compact packaging of the overall phaser assembly. Disposing the worm and motor axes parallel to the phaser axis tends to create a longer phaser which can be more difficult to fit within the overall engine envelope in a vehicle. However, this disposition should not be considered as limiting, and motor 134 and worm 132 may be normal, parallel, or at any angle in between, to the camshaft axis.

To prepare for engine starting, the engine controller (not shown) directing the phaser can drive the phaser to a pre-established, desired position before or during engine cranking. Further, the controller can include software for failure detection and remediation strategies. Concerning failure detection, the motor position and required current levels may be used to detect abnormal positioning, abnormal friction, and motor drive malfunctions, for example. A remediation strategy for this or other faults may consist in driving the mechanism to a preferred fallback position such as full retard for an intake valve camshaft and full advance for an exhaust valve camshaft.

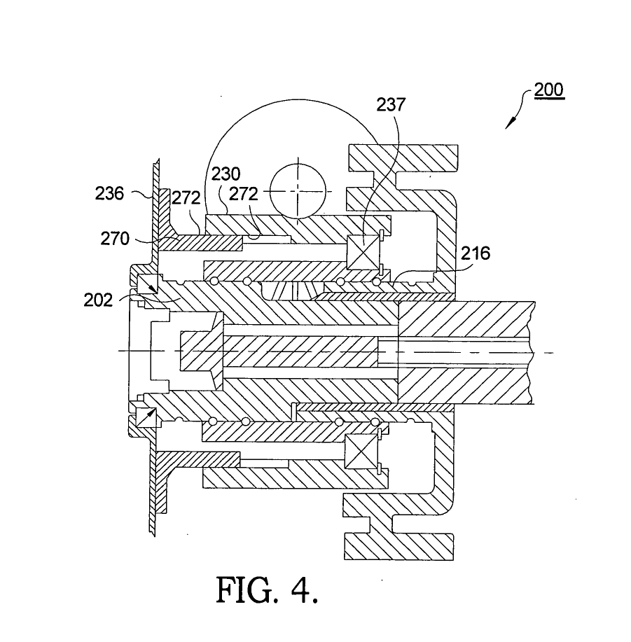

Referring now to FIGS. 3 and 4, a second phaser embodiment 200 in accordance with the invention incorporates several departures from first embodiment 100. Analogous or identical items carry analogous part numbers in the 200 series.

First, by providing a cylindrical flange 270 extending axially from either sprocket/pulley 218 (FIG. 3), or housing 236 (FIG. 4), operatively connected to the camshaft, as a bearing surface 272 for worm gear 230, one thrust bearing is obviated, at a reduction in manufacturing cost and complexity. Only one thrust bearing 235 or 237 is required to connect the nut with the worm gear. Preferably, both the outer surface of flange 270 and the corresponding inner surface 272 of worm gear 230 are threaded together, improving the alignment of the helical mechanisms with the camshaft.

Second, the respective helical mechanisms 202,216 may be lead screws (as shown in FIG. 3 but not FIG. 4) having raised helical splines 274,276 rather than ball screws having helical races 112,124 as in embodiment 100. There are some pros and cons for using helical splines. Splines typically have small helix angles, resulting in a longer phaser. Helical splines also experience higher frictional forces due to sliding action rather than rolling action, resulting in lower mechanical efficiency of the phaser. On the plus side, the use of line contact rather than point contact (as in rolling balls) serves to distribute stresses over a broader surface. Also, splines are inherently self-locking, an advantage which frees the motive mechanism from also being self-locking. Note that nut 226 must have both left- and right-handed grooves or threads to accommodate splines 274,276.

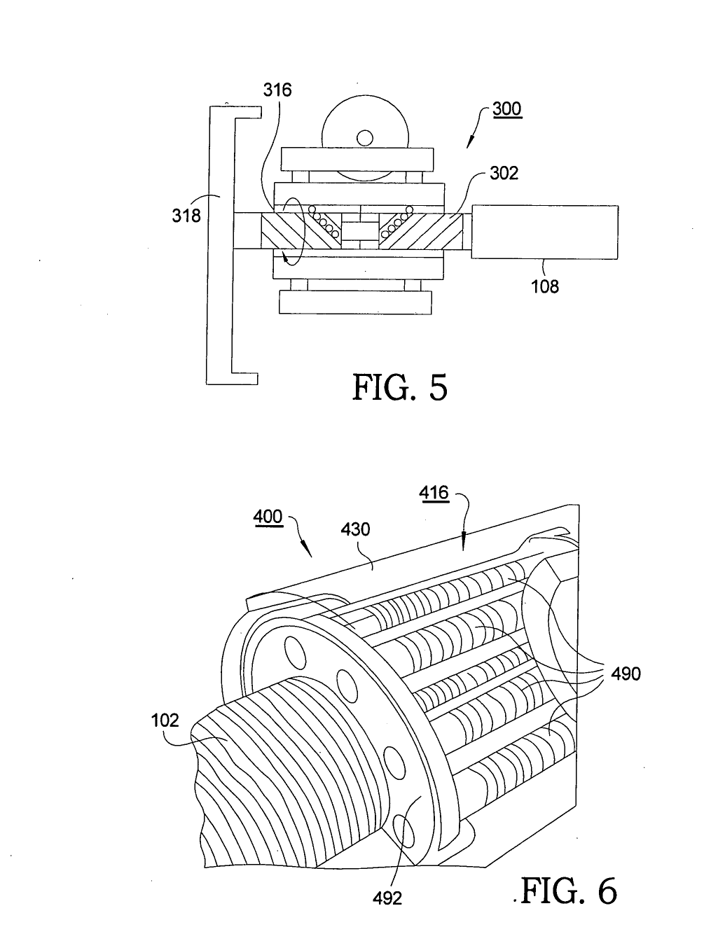

Referring again to FIG. 1, an important feature of embodiment 100 is that the pulley or sprocket 118 is located in axial proximity to the outer end of camshaft 108, allowing the camshaft outer bearings (not shown) to support the load from the driving chain or belt. Referring to FIG. 5, in third embodiment 300, the pulley/sprocket 318 and second helical mechanism 316 are disposed opposite camshaft 108 and first helical mechanism 302. Although consistent with the invention, this embodiment is not currently favored because pulley/sprocket 318 is axially removed from the camshaft, thus increasing the axial length of the phaser and increasing the radial load on the camshaft outer bearings.

Referring now to FIG. 6, in a fourth embodiment 400 of a phaser in accordance with the invention, a planetary roller screw assembly 416 having a plurality of planet rollers 490 in a cage 492 replaces nut 126 and is driven by worm gear 430. This arrangement has the advantages of a) having line contact versus just 2 or 4 point contacts as in first embodiment 100; b) increased accuracy and stability: in a linear actuator, for example, a ball screw typically exhibits a stability of 0.0010 inch/foot, whereas a planetary roller screw can triple that stability to about 0.0003 inch/foot; and c) the overall cost of a phaser can be reduced.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A camshaft phaser for controllably varying the phase relationship between a crankshaft and a camshaft in an internal combustion engine, comprising:
a) a first helical mechanism operatively connected to said engine camshaft for rotation therewith and having a first helical direction selected from right-handed and left-handed progressions;
b) a second helical mechanism operatively connected to said crankshaft and disposed colinearly with said first helical mechanism and having a second helical direction opposite to said first helical direction;
c) a nut overlapping both of said first and second colinear helical mechanisms and engaged therewith; and
d) a nut driver for driving said nut axially of said first and second colinear helical mechanisms to vary the phase relationship therebetween.

2. A camshaft phaser in accordance with claim 1 wherein at least one of said first helical mechanism and said second helical mechanism includes a ball screw having helical races on an outer surface thereof.

3. A camshaft phaser in accordance with claim 1 wherein at least one of said first helical mechanism and said second helical mechanism includes a lead screw having helical splines on an outer surface thereof.

4. A camshaft phaser in accordance with claim 1 wherein said nut includes a planetary roller screw.

5. A camshaft phaser in accordance with claim 1 wherein said nut driver is disposed for driving said nut rotationally simultaneously.

6. A camshaft phaser in accordance with claim 1 wherein said nut driver includes a worm gear surrounding said nut.

7. A camshaft phaser in accordance with claim 6 wherein said worm gear is supported by at least one thrust bearing disposed between said worm gear and said nut.

8. A camshaft phaser in accordance with claim 6 wherein said nut driver further includes a worm engaged with said worm gear.

9. A camshaft phaser in accordance with claim 8 wherein said worm is disposed on an output shaft of an electric motor.

10. A camshaft phaser in accordance with claim 7 wherein said phaser includes a housing connected to said camshaft and wherein said worm gear is supported at a first end by said at least one thrust bearing and is supported at a second and opposite end by a cylindrical flange extending from one of said sprocket/pulley and said housing.

11. A camshaft phaser in accordance with claim 10 wherein said worm gear and said cylindrical flange are in threaded relationship.

12. An internal combustion engine comprising a camshaft phaser for controllably varying the phase relationship between a crankshaft and a camshaft in said engine, said camshaft phaser including
a first helical mechanism operatively connected to said engine camshaft for rotation therewith and having a first helical direction selected from right-handed and left-handed progressions,
a second helical mechanism operatively connected to said crankshaft and disposed colinearly with said first helical mechanism and having a second helical direction opposite to said first helical direction,
a nut overlapping both of said first and second colinear helical mechanisms and engaged therewith, and
a nut driver for driving said nut axially of said first and second colinear helical mechanisms to vary the phase relationship therebetween.
